(19) United States
(12) Patent Application Publication
(10) Pub. No.: US 2025/0240556 A1
(43) Pub. Date: Jul. 24, 2025

(54) SPEAKER UNIT FOR EARPHONE

(71) Applicant: ALMUS Corp., Chungcheongnam-do (KR)

(72) Inventors: Jong Won LEE, Incheon (KR); Yun Uk Ha, Incheon (KR); Jeong Kwon Park, Gyeonggi-do (KR); Seung Ki Kim, Incheon (KR); Soon Hyuk Hong, Gyeonggi-do (KR)

(21) Appl. No.: 19/033,702

(22) Filed: Jan. 22, 2025

(30) Foreign Application Priority Data
Jan. 24, 2024 (KR) 10-2024-0010567

(51) Int. Cl. H04R 1/10

(52) U.S. Cl. CPC H04R 1/1083

(57) ABSTRACT

Provided is a speaker unit for an earphone, comprising: a speaker frame accommodated within an earphone housing and having an internal space formed therein; a low-tone speaker arranged within the speaker frame and configured to output low-tone; and a high-tone speaker positioned above the low-tone speaker in the speaker frame and configured to output high-tone, wherein the low-tone speaker is arranged to have the same sound output direction as that of the high-tone speaker, and the high-tone speaker has a relatively smaller size compared to the low-tone speaker.

### CROSS-REFERENCE TO RELATED APPLICATION

This application claims priority from Korean Patent Application No. 10-2024-0010567 filed on Jan. 24, 2024 in the Korean Intellectual Property Office, the contents of which in its entirety are herein incorporated by reference.

### FIELD

The present invention relates to an earphone, and more specifically, to a speaker unit for an earphone in which a low-tone speaker and a high-tone speaker are integrally formed.

### BACKGROUND

An earphone includes a speaker unit that generates sound waves inside a housing.

The speaker unit may include a diaphragm, a magnet, a coil, and a plate. When current is applied to the coil, the coil becomes magnetic, and through the electrical interaction between the coil and the plate, the coil moves, causing the diaphragm to move. Such speaker units include both a configuration for reproducing low-frequency sound and a configuration for reproducing high-frequency sound (a two-way type).

In the conventional two-way speaker acoustic structure, a low-tone speaker (woofer speaker) and a high-tone speaker (tweeter speaker) are configured together in opposite directions on the same axis. Consequently, the sound direction of the low-tone speaker and the sound direction of the high-tone speaker are opposite, meaning that the sound phases are reversed, which results in a problem where sound attenuation occurs in certain frequency bands where the low-tone speaker and high-tone speaker produce sound simultaneously.

Meanwhile, recently, earphones equipped with active noise cancellation (ANC) technology have been gaining attention as a method for eliminating ambient noise components during listening. ANC is a technology that collects noise from the external environment using a microphone, generates a signal with a 180-degree phase difference relative to the collected noise, and removes the noise components through signal superposition.

To implement the ANC function, a microphone must be mounted inside the earphone. However, providing additional space for microphone installation or adding separate components for mounting the microphone may hinder the miniaturization of the earphone or ease of its assembly. Furthermore, the microphone and the mounting structure may also degrade the sound quality.

### SUMMARY

An objective of the present invention is to provide a speaker unit for an earphone unit in which a low-tone speaker and a high-tone speaker are arranged in the same direction to align their sound phases, while enabling the minimization of the earphone's size even when a microphone is mounted inside.

The objective to be achieved by the present invention is not limited to the foregoing objective, and additional objectives, which are not mentioned herein, will be readily understood by those skilled in the art from the following description.

According to the present invention, a speaker unit for an earphone includes: a speaker frame accommodated within an earphone housing and having an internal space formed therein; a low-tone speaker disposed within the speaker frame and configured to output low-tone; and a high-tone speaker positioned above the low-tone speaker in the speaker frame and configured to output high-tone, wherein the low-tone speaker is arranged to have the same sound output direction as that of the high-tone speaker, and the high-tone speaker has relatively smaller size compared to the low-tone speaker.

The speaker frame may be a single integrated frame.

The speaker frame may include at least one of a tuning vent hole for acoustic characteristics of the low-tone speaker and a pressure vent hole for balancing air pressure between an ear canal and an external environment on one side.

The tuning vent hole and the pressure vent hole may be arranged together on a side surface of the speaker frame.

The low-tone speaker may include a low-tone yoke disposed on a lower side within the speaker frame; a low-tone central magnet disposed above the low-tone yoke; a low-tone ring magnet disposed outside the low-tone central magnet and above the low-tone yoke; a low-tone ring coil positioned between an outer side of the low-tone central magnet and an inner side of the low-tone ring magnet and configured to move vertically; and a low-tone diaphragm coupled to one end of the low-tone ring coil and configured to output the low-tone upward by vibrating in response to the vertical movement of the low-tone ring coil.

The low-tone yoke may include a plate-shaped structure.

The high-tone speaker may include a plate-shaped high-tone yoke disposed above the low-tone diaphragm within the speaker frame; a high-tone central magnet disposed above the high-tone yoke; a high-tone ring magnet arranged above the high-tone yoke and on an outer side of the high-tone central magnet; a high-tone plate-shaped coil disposed above the high-tone central magnet and the high-tone ring magnet; and a high-tone diaphragm disposed above the high-tone plate-shaped coil and configured to output the high-tone in the same upward direction as the low-tone speaker.

The high-tone plate-shaped coil may include a plate-shaped ring structure.

The high-tone plate-shaped coil may be formed as a coil structure or as a shaped circuit pattern on a flexible substrate.

A flexible substrate for the high-tone may be provided on an outer side of the high-tone plate-shaped coil to supply an electrical signal to the high-tone plate-shaped coil, a central portion of the flexible substrate for the high-tone may have a hollow ring shape, and the high-tone plate-shaped coil may be positioned in the central portion.

The speaker unit may further include a microphone configured to convert external sound into an electrical signal, and the microphone may be arranged on a lateral portion of the high-tone speaker within the speaker frame.

### Effects of the Invention

According to the present invention described above, a high-tone speaker configured to output high-tone is placed in front of a low-tone speaker configured to output low-tone with their sound output directions aligned in the same direction, which ensures that the output sounds are in phase, thereby minimizing sound loss.

Additionally, in the case of the high-tone speaker, the use of a plate-shaped coil for a voice coil allows the size of the speaker to be minimized while maintaining the quality of the output sound.

Furthermore, as the size of the speaker can be minimized, additional space can be secured to accommodate the installation of a microphone.

### BRIEF DESCRIPTION OF THE DRAWINGS

FIG. 1A is a perspective view of a speaker unit for an earphone according to the present invention.

FIG. 1B is a cross-sectional view of the speaker unit for an earphone shown in FIG. 1A.

FIG. 2 is an exploded view of the speaker unit for an earphone shown in FIGS. 1A and 1B.

FIG. 3 is an enlarged perspective view of a speaker frame of one embodiment.

FIG. 4 is a side cross-sectional view of a high-tone speaker according to one embodiment.

FIG. 5 illustrates examples of a high-tone plate-shaped coil implemented as a coil structure.

FIG. 6 illustrates a high-tone plate-shaped coil implemented as a shaped circuit pattern on a flexible substrate.

FIG. 7 illustrates reference diagrams related to the formation of a magnetic field according to a high-tone plate-shaped coil.

FIG. 8 is a reference view illustrating a flexible substrate for high-tone.

FIG. 9 is a reference diagram illustrating a state in which a microphone is mounted within a speaker frame.

### DETAILED DESCRIPTION

Hereinafter, embodiments of the present invention will be described in detail with reference to the drawings. Hereinafter, throughout the description and the attached drawings, substantially like elements will be referred to as like reference numerals and a repetitive description thereof will be omitted. Also, in a description of the embodiments of the present invention, a detailed description of well-known functions or components of the related art will be omitted when it is deemed to obscure understanding of the embodiments of the present invention.

An earphone according to embodiments of the present invention includes at least one microphone which receives external noise for active noise cancellation (ANC). The earphone according to the embodiments of the present disclosure is a wireless earphone, but the present invention may be applied to a wired earphone as well as a wireless earphone.

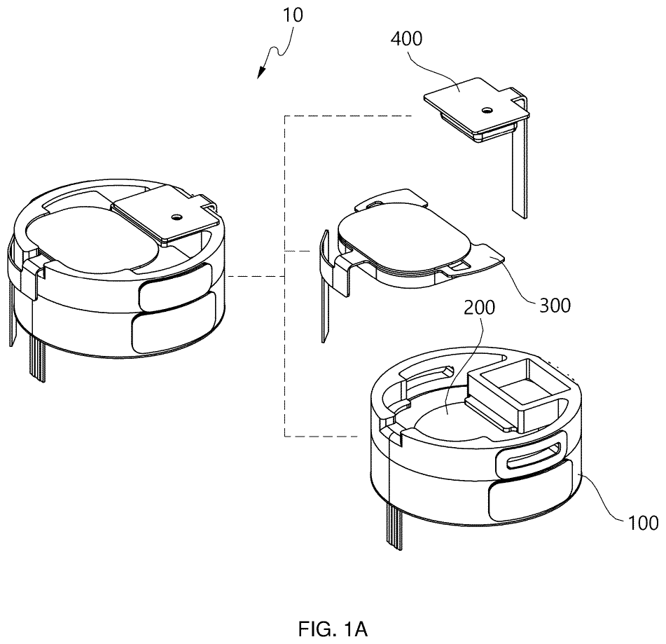

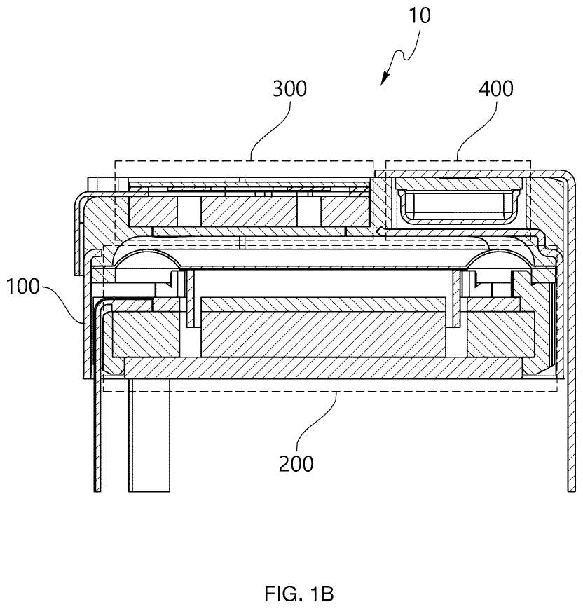

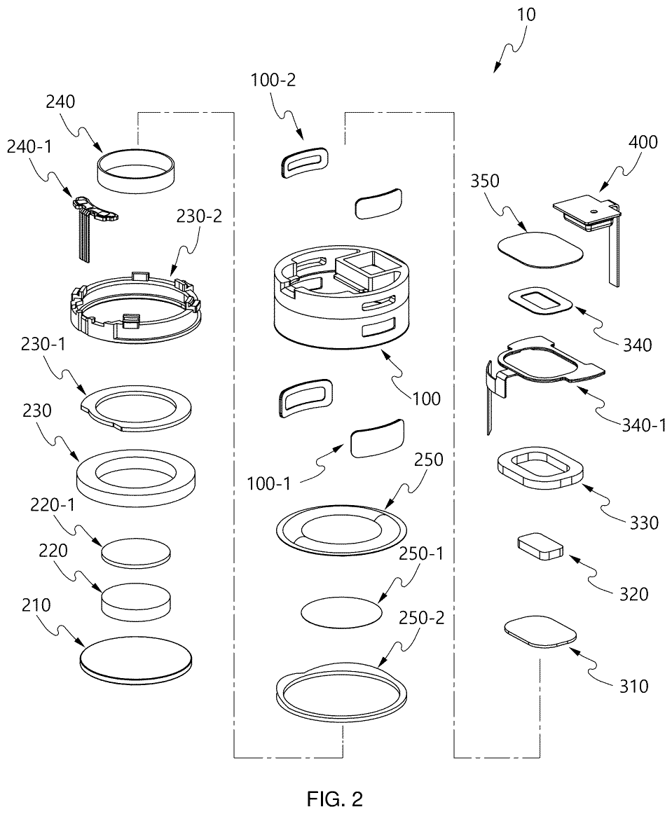

FIG. 1A is a perspective view of a speaker unit 10 for an earphone according to an embodiment of the present invention, and FIG. 1B is a cross-sectional view of the speaker unit 10 for an earphone shown in FIG. 1A. In addition, FIG. 2 is an exploded view of the speaker unit 10 for an earphone shown in FIGS. 1A and 1B.

The speaker unit 10 for an earphone according to the embodiment shown in FIGS. 1A, 1B, and 2 may include a speaker frame 100, a low-tone speaker 200, a high-tone speaker 300, and a microphone 400.

The speaker frame 100 is accommodated within an earphone housing not shown, and has an internal space.

The speaker 200 may accommodate the low-tone speaker 200, the high-tone speaker 300, and the microphone 400 in the internal space.

The speaker frame 100 has a structure to secure the low-tone speaker 200, the high-tone speaker 300, and the microphone 400 using a single injection-molded frame. The speaker frame 100 may include components formed through insert molding, such as a metal frame that defines the external shape and internal volume, a metal support that functions as an acoustic shield beneath the microphone 400, and a mesh component for controlling airflow for pressure equalization. The speaker frame 100 has a structure where the internal structure of the low-tone speaker 200 can be inserted from below, while the high-tone speaker 300 and the microphone 400 can be seated from above. The front of the speaker frame 100 provides an open space for low-tone radiation, and the lateral surface includes pressure vent holes for air pressure equalization and tuning vent holes for acoustic tuning of the low-tone speaker 200.

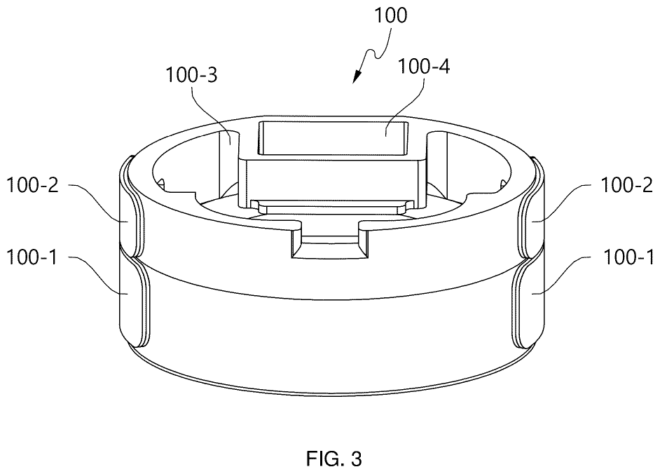

FIG. 3 is an enlarged perspective view of the speaker frame 100 of one embodiment.

The speaker frame 100 in FIG. 3 includes a single integrated frame structure.

The speaker frame 100 may accommodate the low-tone speaker 200 in the lower part of its internal space. To accommodate the low-tone speaker 200, the speaker frame 100 may have a tubular structure with an open central portion. The tubular structure may include a cylindrical structure, a polygonal tube structure, or the like.

The speaker frame 100 has at least one tuning vent hole 100-1 and/or at least one pressure vent hole 100-2 formed on one side of the frame (e.g., on a lateral surface). The tuning vent hole 100-1 and the pressure vent hole 100-2 may be arranged together on the lateral surface of the speaker frame 100.

The tuning vent hole 100-1 is a vent hole to tune the acoustic characteristics of the low-tone speaker 200. Additionally, the pressure vent hole 100-2 functions as a pressure equalization pathway between the speaker unit 10 and the external environment. The pressure vent hole 100-2 allows communication between the pressure at the acoustic exit and the external atmospheric pressure, ensuring that the air pressure in the ear canal is maintained equal to the external atmospheric pressure.

The cross-sections of the tuning vent hole 100-1 and/or the pressure vent hole 100-2 have a rectangular structure with rounded edges. However, this is merely an example, and the structure may include circular holes or other polygonal hole shapes.

The tuning vent hole 100-1 and/or the pressure vent hole 100-2 may each be provided as a single vent hole in the speaker frame 100 but may also be provided as two or more vent holes. When two or more vent holes are provided, they may be positioned on the lateral surface of the speaker frame 100 in opposing directions. A vent filter is coupled to the tuning vent hole 100-1 and/or the pressure vent hole 100-2. The vent filter may be a mesh member coupled to the front of the tuning vent hole 100-1 and/or the pressure vent hole 100-2. The vent filter may be attached to the mesh member or inserted into an injection-molded frame.

The speaker frame 100 accommodates the high-tone speaker 300 and/or the microphone 400 in the upper part of its internal space. For this purpose, the internal space of the speaker frame 100 includes a speaker receiving opening 100-3 to accommodate the high-tone speaker 300 and a microphone receiving recess 100-4 to accommodate the microphone.

The speaker receiving opening 100-3 includes a structure in which the high-tone speaker 300 can be seated. To accommodate the high-tone speaker 300, the speaker receiving opening 100-3 includes a tubular structure at its center, which may include a cylindrical structure, a polygonal tube structure, or a semi-cylindrical structure.

The microphone receiving recess 100-4 is a groove structure positioned on the lateral side of the speaker housing 100-3 to accommodate the microphone 400. The microphone receiving recess 100-4 has an open groove structure in the direction of sound emission (upward from the speaker frame 100 shown in FIG. 3). The microphone receiving recess 100-4 has a groove structure corresponding to the shape of the microphone 400, such as a rectangular prism structure, a cylindrical structure, a polygonal tube structure, or the like, to accommodate the microphone 400.

The low-tone speaker 200 is arranged within the speaker frame 100 and outputs low-tone. The low-tone speaker 200 is positioned so that its sound output direction is aligned with that of the high-tone speaker 300.

Referring to FIGS. 1B and 2, the low-tone speaker 200 includes a low-tone yoke 210, a low-tone central magnet 220, a low-tone ring magnet 230, a low-tone ring coil 240, and a low-tone diaphragm 250.

The low-tone yoke 210 is disposed on the lower side within the speaker frame 100 shown in FIG. 3. The low-tone yoke 210 includes a plate-shaped structure. The plate-shaped structure may be a circular planar structure or a polygonal (e.g., rectangular, hexagonal) structure.

The low-tone central magnet 220 is disposed above the low-tone yoke 210. This low-tone central magnet 220 is a magnetic body with a block structure of a certain thickness. The block structure may be a circular block structure, a polygonal (e.g., rectangular, hexagonal) block structure, or the like. The low-tone central magnet 220 interacts electromagnetically with the low-tone ring coil 240.

The lower surface of the low-tone central magnet 220 may be arranged in close contact with the upper surface of the low-tone yoke 210 having a plate-shaped structure. In addition, a planar plate 220-1 may be positioned on the upper surface of the low-tone central magnet 220. The planar plate 220-1, together with the low-tone central magnet 220 and the low-tone ring magnet 230, forms a magnetic field. The planar plate 220-1 may be a circular planar plate or a polygonal planar plate.

The low-tone ring magnet 230 is arranged above the low-tone yoke 210 and on the outer side of the low-tone central magnet 220. That is, the low-tone central magnet 220 may be positioned within a hollowed portion of the low-tone ring magnet 230.

The low-tone ring magnet 230 is a magnetic body having a ring structure with a hollow center portion, and the thickness of the ring structure may correspond to the thickness of the block structure of the low-tone central magnet 220.

The inner surface of the low-tone ring magnet 230 is arranged at a certain distance from the outer surface of the low-tone central magnet 220, which is a block-shaped magnetic body. The low-tone ring coil 240 may be positioned between the low-tone ring magnet 230 and the low-tone central magnet 220, which are spaced apart at the distance. The low-tone ring magnet 230 interacts electromagnetically with the low-tone ring coil 240.

The lower surface of the low-tone ring magnet 230 may be arranged in close contact with the upper surface of the low-tone yoke 210, which has a plate-shaped structure. In addition, a ring plate 230-1 may be positioned on the upper surface of the low-tone ring magnet 230. The ring plate 230-1, together with the low-tone ring magnet 230 and the low-tone central magnet 220, forms a magnetic field. The ring plate 230-1 may be a circular ring plate or a polygonal ring plate.

A magnet frame 230-2 for securing the low-tone ring magnet 230 is arranged on the outer side of the low-tone ring magnet 230. The interior of the magnet frame 230-2 includes a space for accommodating the low-tone ring magnet 230, and the outer portion of the magnet frame 230-2 has a structure that can be housed within the speaker frame 100.

The low-tone ring coil 240 is positioned between the outer side of the low-tone central magnet 220 and the inner side of the low-tone ring magnet 230, and moves vertically. The low-tone ring coil 240 is a coil that performs electromagnetic interaction between the low-tone central magnet 220 and the low-tone ring magnet 230.

To this end, the low-tone ring coil 240 may have a cylindrical coil structure. One end (the upper end) of the cylindrical coil is fixed to the low-tone diaphragm 250. The other end (the lower end) of the cylindrical coil is positioned to overlap between the low-tone central magnet 220 and the low-tone ring magnet 230. Additionally, a flexible substrate 240-1 for low-tone is provided around the low-tone ring coil 240 to supply an electrical signal. The low-tone flexible substrate 240-1 may be made of a flexible material.

When the low-tone ring coil 240 moves due to electromagnetic interaction, the low-tone diaphragm 250 moves in response. That is, when a current is applied to the low-tone ring coil 240, the coil becomes magnetic, and according to the polarity of the magnetic force of the low-tone ring coil 240, the low-tone ring coil 240 moves, causing the low-tone diaphragm 250 fixed to the low-tone ring coil 240 to move as well.

The low-tone diaphragm 250 outputs low-tone through its vibration. The central portion of the low-tone diaphragm 250 is coupled to one end of the low-tone ring coil 240, and as the low-tone ring coil 240 moves vertically, the low-tone diaphragm 250 vibrates, outputting low-tone in the upward direction.

The low-tone diaphragm 250 is a film-like member and may have a dome shape. The low-tone diaphragm 250 may be made of a material with high elasticity. The high elasticity of the low-tone diaphragm 250 may allow for excellent sound performance capable of reproducing sounds close to the original. For example, the low-tone diaphragm 250 may be made of rubber-based materials such as silicone (liquid or solid), elastomer, polyurethane, acrylic rubber, and the like.

The central portion of the low-tone diaphragm 250 may additionally include a central diaphragm 250-1, and the edge portion of the low-tone diaphragm 250 is provided with a diaphragm fixing ring 250-2 to secure the low-tone diaphragm 250. The diaphragm fixing ring 250-2 includes a ring structure that can be coupled to the edge portion of the low-tone diaphragm 250, and the diaphragm fixing ring 250-2 with the ring structure may be seated within the speaker frame 100.

The sound output direction of the low-tone diaphragm 250 is arranged to be in the same direction as the sound output direction of the high-tone speaker 300. Specifically, since the low-tone ring coil 240 is positioned and coupled below the low-tone diaphragm 250, the vertical movement of the low-tone ring coil 240 causes the low-tone diaphragm 250 to output sound in the same direction as the sound output direction (upward direction in FIG. 2) of the high-tone speaker 300.

In conventional speaker acoustic structures, the low-tone speaker and the high-tone speaker are configured in opposite directions on the same axis. As a result, the sound output directions of the low-tone speaker and the high-tone speaker are opposite, causing sound attenuation in certain frequency bands where the sounds from both speakers are generated simultaneously.

In contrast, the present invention prevents sound attenuation in the frequency bands where the sounds from the low-tone speaker and the high-tone speaker occur simultaneously, by placing the high-tone speaker in front of the low-tone speaker, corresponding to the sound output direction of the low-tone speaker, thereby ensuring that the sounds from both speakers are in phase.

The high-tone speaker 300 is arranged within the speaker frame 100 and outputs high-tone. The high-tone speaker 300 is positioned to have the same sound output direction as the low-tone speaker 200.

Referring to FIGS. 1B and 2, the high-tone speaker 300 includes a high-tone yoke 310, a high-tone central magnet 320, a high-tone ring magnet 330, a high-tone plate-shaped coil 340, and a high-tone diaphragm 350.

The high-tone yoke 310 is positioned at the upper part of the speaker frame 100. Specifically, the high-tone yoke 310 may be arranged within the speaker receiving opening 100-3 of the speaker frame 100. In this case, the high-tone yoke 310 is disposed above the low-tone diaphragm 250 within the speaker receiving opening 100-3. The high-tone yoke 310 includes a plate-shaped structure. The plate-shaped structure may be a circular plate-shaped structure or a polygonal (e.g., rectangular, hexagonal) plate-shaped structure.

The high-tone central magnet 320 is disposed above the high-tone yoke 310. The high-tone central magnet 320 is a magnetic body with a block structure of a certain thickness. The block structure may be a circular block structure, a polygonal (e.g., rectangular, hexagonal) block structure, or the like. The high-tone central magnet 320 interacts electromagnetically with the high-tone plate-shaped coil 340.

The lower surface of the high-tone central magnet 320 may be arranged in close contact with the upper surface of the high-tone yoke 310 with a plate-shaped structure. The high-tone central magnet 320, together with the high-tone ring magnet 330 and the high-tone plate-shaped coil 340, forms a magnetic field.

The high-tone ring magnet 330 is arranged above the high-tone yoke 310 and on the outer side of the high-tone central magnet 320. That is, the high-tone central magnet 320 may be positioned within a hollowed portion of the high-tone ring magnet 330.

The high-tone ring magnet 320 is a magnetic body having a ring structure with a hollow center portion, and the thickness of the ring structure may correspond to the thickness of the block structure of the high-tone central magnet 320.

The inner surface of the high-tone ring magnet 330 is arranged at a certain distance from the outer surface of the high-tone central magnet 320, which is a block-shaped magnetic body. The high-tone plate-shaped coil 340 may be positioned between the high-tone ring magnet 330 and the high-tone central magnet 320, which are spaced apart at the distance. The high-tone ring magnet 330 interacts electromagnetically with the high-tone central magnet 320 and the high-tone plate-shaped coil 340. The lower surface of the high-tone ring magnet 330 may be arranged in close contact with the upper surface of the high-tone yoke 310 with a plate-shaped structure.

The high-tone plate-shaped coil 340 is disposed above the high-tone central magnet 320 and the high-tone ring magnet 330. The high-tone plate-shaped coil 340 is a coil that performs electromagnetic interaction between the high-tone central magnet 320 and the high-tone ring magnet 330.

The high-tone diaphragm 350 moves due to the electromagnetic interaction of the high-tone plate-shaped coil 340. That is, when a current is applied to the high-tone plate-shaped coil 340, the coil becomes magnetic, and the high-tone diaphragm 350 moves according to the polarity of the magnetic force of the high-tone plate-shaped coil 340.

A flexible substrate 340-1 for high-tone is provided on the outer side of the high-tone plate-shaped coil 340 to supply an electrical signal to the high-tone plate-shaped coil 340. The central portion of the flexible substrate 340-1 for high-tone may be hollow, and the high-tone plate-shaped coil 340 may be positioned in the central portion of the substrate. The flexible substrate 340-1 for high-tone may be made of a flexible material.

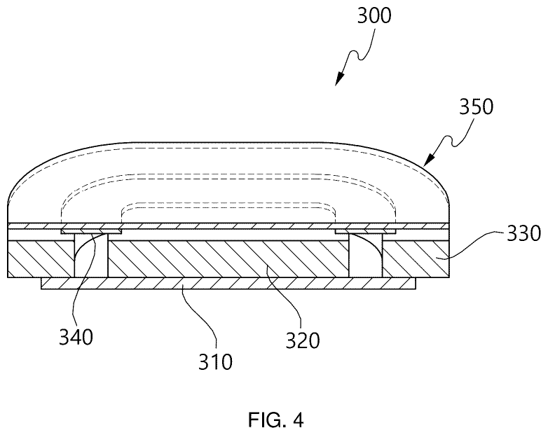

FIG. 4 is a side cross-sectional view of the high-tone speaker 300 according to one embodiment.

Referring to FIG. 4, the low-tone plate-shaped coil 340 may have a plate-shaped coil structure. The lower surface of the plate-shaped coil structure is positioned above the high-tone central magnet 320 and the high-tone ring magnet 330 and may be located in the upper part of the separation space between the outer side of the high-tone central magnet 320 and the inner side of the high-tone ring magnet 330. Additionally, the upper surface of the plate-shaped coil structure is fixed to the high-tone diaphragm 350.

In conventional high-tone speakers, a coil in a vertical cylindrical structure is positioned between magnets, requiring an upper plate to be placed above the magnets. Moreover, the coil positioned between the magnets requires a certain height to drive the speaker, which limits the reduction of the overall height of the speaker. In contrast, the high-tone plate-shaped coil 340 of the present invention includes a horizontal plate-shaped structure. As the plate-shaped coil is positioned above the magnets, no additional plate components are required above the magnets, allowing the height of the magnet components to be reduced, which in turn reduces the overall height of the speaker.

The high-tone plate-shaped coil 340 refers to a coil with a horizontal dimension wider than its vertical dimension, comprising a two-dimensional spiral structure formed by winding a wire-shaped conductor that allows electrical signals to flow, such as copper or aluminum, either inward from the outer edge or outward from the inner edge.

The high-tone plate-shaped coil 340 may be implemented as a separate coil product or as a shaped circuit pattern on a flexible substrate.

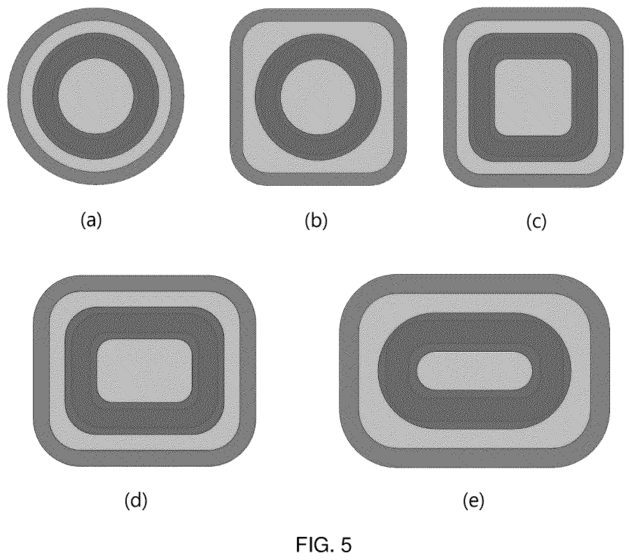

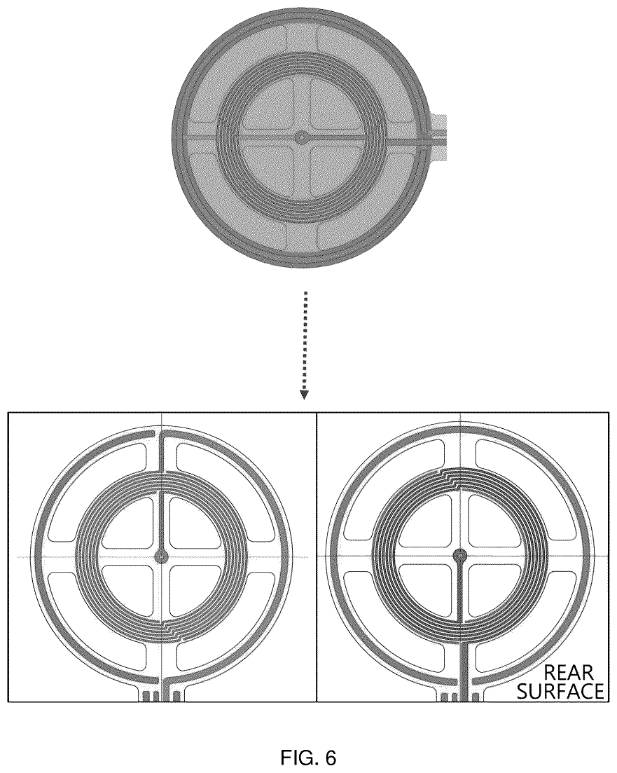

FIG. 5 illustrates examples of the high-tone plate-shaped coil 340 implemented as a coil structure, and FIG. 6 illustrates the high-tone plate-shaped coil 340 implemented as a shaped circuit pattern on a flexible substrate.

As shown in FIGS. 5 and 6, the high-tone plate-shaped coil 340 may have inner and outer shapes corresponding to the two magnet shapes positioned beneath the coil, and may be circular, square, rectangular, or a shape with two rounded sides and two straight sides.

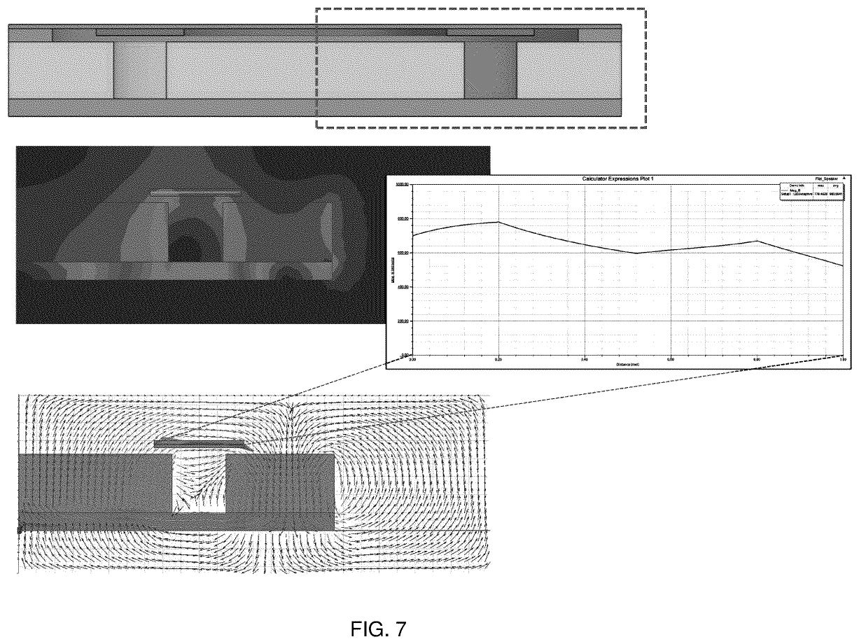

FIG. 7 illustrates reference diagrams related to the formation of a magnetic field according to the high-tone plate-shaped coil 340.

Referring to FIG. 7, the high-tone plate-shaped coil 340 has a structure that optimizes magnetic efficiency in a speaker with low amplitude. Specifically, in conventional speakers, since a magnetic field passes between an inner plate and an outer plate located above two magnets, the magnetic field is concentrated at the center of the coil, and the upper and lower portions of the coil have low magnetic field efficiency, resulting in reduced magnetic efficiency relative to the total coil length when the speaker amplitude is small. In contrast, according to the high-tone plate-shaped coil 340 of the present invention, a magnetic field curves and passes horizontally through a plate-shaped voice coil between the two magnets. This causes the magnetic field to be evenly distributed across the entire coil, thereby improving magnetic efficiency in a speaker with low amplitude.

A flexible substrate 340-1 for high-tone is provided on the outer side of the high-tone plate-shaped coil 340 to supply an electrical signal to the high-tone plate-shaped coil 340. The central portion of the flexible substrate 340-1 for high-tone may have a hollow ring shape, and the high-tone plate-shaped coil 340 may be positioned in the center of the substrate. The flexible substrate 340-1 for high-tone may be made of a flexible material.

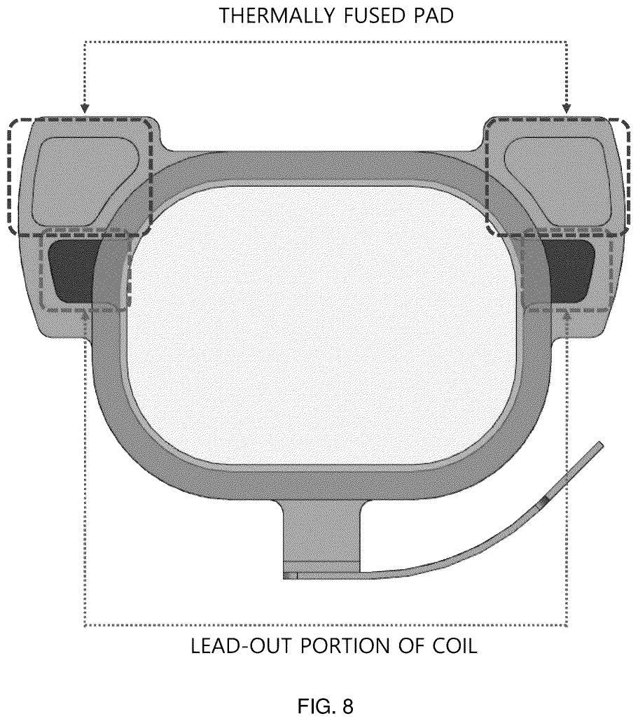

FIG. 8 is a reference view illustrating the flexible substrate 340-1 for high-tone.

Referring to FIG. 8, the flexible substrate 340-1 for high-tone has a structure to replace the ring that secures the high-tone diaphragm 350, and may serve to maintain the shape of the high-tone diaphragm 350 and fix the position of the high-tone plate-shaped coil 340.

Additionally, the flexible substrate 340-1 for high-tone includes a reinforcement plate made of a material such as film, attached separately from the circuit to maintain rigidity and a specific height. Furthermore, a thermally fused portion, which is electrically connected to the high-tone plate-shaped coil 340, is located outside the high-tone diaphragm 350. Since a lead-out portion that functions as a passage for allowing the high-tone plate-shaped coil 340 to exit from the inside to the outside of the high-tone diaphragm 350 is formed on one side of the flexible substrate 340-1, when the flexible substrate 340-1 and the high-tone ring magnet 330 are attached, the flexible substrate 340-1 is prevented from being separated from the high-tone ring magnet 330 by the high-tone plate-shaped coil 340.

The high-tone diaphragm 350 outputs high-tone through vibration. The high-tone diaphragm 350 is positioned above the high-tone plate-shaped coil 340 and outputs high-tone in the upward direction, similar to the low-tone speaker 200.

The high-tone diaphragm 350 may be a film-like member and may be made of a material with high elasticity. The high-tone diaphragm 350 may be made of a plastic film material including polyethylene naphthalate (PEN) or polyetheretherketone (PEEK), an elastomer material including thermoplastic polyurethane elastomer (TPU), a rubber material, a metal material including an aluminum material or an alloy material, or a graphene material.

The high-tone diaphragm 350 may be fixed by the high-tone flexible substrate 340-1 with a ring structure.

The high-tone diaphragm 350 outputs high-tone in the upward direction, similar to the low-tone diaphragm 250 of the low-tone speaker 200. Specifically, since the high-tone plate-shaped coil 340 is coupled below the high-tone diaphragm 350, the sound output direction of the high-tone diaphragm 350 may be aligned with the sound output direction of the low-tone speaker 200 (upward direction in FIG. 2) due to the magnetic field generated by the high-tone plate-shaped coil 340.

The microphone 400 converts external sound into an electrical signal. The microphone 400 may be positioned on the lateral portion of the high-tone speaker 300 within the speaker frame 100. Specifically, the microphone 400 may have a size that fits into the microphone receiving recess 100-4 of the speaker frame 100. As shown in FIG. 2, the microphone 400 is illustrated in a rectangular prism shape; however, this is merely an example, and the microphone 400 may be implemented in various shapes, such as cylindrical or a polygon shapes.

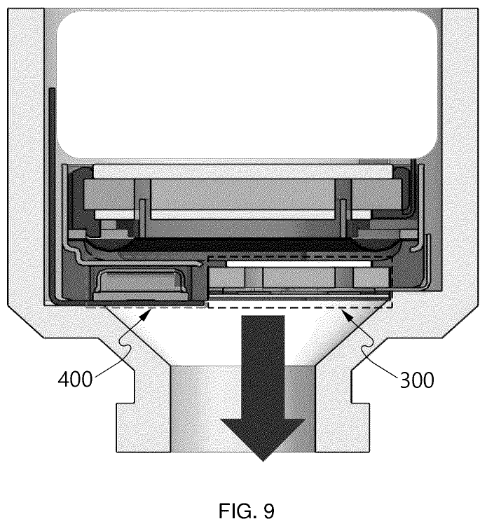

FIG. 9 is a reference diagram illustrating a state in which the microphone 400 is mounted within the speaker frame 100.

In conventional speaker acoustic structures, where no separate microphone is mounted, the microphone is positioned in front of a high-tone speaker during assembly and this placement attenuates high-frequency sounds with short wavelengths, making it difficult to utilize the high-tone of the high-tone speaker at maximum efficiency. In contrast, as shown in FIG. 9, in the speaker structure of the present invention, the microphone 400 is mounted on the lateral surface of the high-tone speaker 300, which allows space at the front of the speaker to remain available during assembly, enabling the high-tone from the high-tone speaker 300 to be radiated without loss. Additionally, since no separate space is required for the microphone 400 at the front of the speaker, the size of the speaker unit for an earphone can be minimized.

The example embodiments of the present invention have been described above. It should be understood by one of ordinary skill in the art that the present invention may be implemented as a modified form without departing from the essential features of the present invention. Therefore, the preferred embodiments should be considered in descriptive sense only and not for purposes of limitation.

### REFERENCE NUMERALS

10: Speaker UNIT FOR EARPHONE
100: SPEAKER Frame
200: LOW-TONE SPEAKER
300: HIGH-TONE SPEAKER
400: microphone

What is claimed:

1. A speaker unit for an earphone, the speaker unit configured to generate sound and output the sound externally and comprising:
a speaker frame accommodated within an earphone housing and having an internal space formed therein;
a low-tone speaker arranged within the speaker frame and configured to output low-tone; and
a high-tone speaker positioned above the low-tone speaker in the speaker frame and configured to output high-tone,
wherein the low-tone speaker is arranged to have the same sound output direction as that of the high-tone speaker, and the high-tone speaker has a relatively smaller size compared to the low-tone speaker.

2. The speaker unit of claim 1, wherein the speaker frame is a single integrated frame.

3. The speaker unit of claim 1, wherein the speaker frame includes at least one of a tuning vent hole for acoustic characteristics of the low-tone speaker or a pressure vent hole for balancing air pressure between an ear canal and an external environment on one side.

4. The speaker unit of claim 3, wherein the tuning vent hole and the pressure vent hole are arranged together on a lateral surface of the speaker frame.

5. The speaker unit of claim 1, wherein the low-tone speaker comprises
a low-tone yoke disposed on a lower side within the speaker frame;
a low-tone central magnet disposed above the low-tone yoke;
a low-tone ring magnet arranged above the low-tone yoke and on an outer side of the low-tone central magnet;
a low-tone ring coil positioned between the outer side of the low-tone central magnet and an inner side of the low-tone ring magnet and configured to move vertically; and
a low-tone diaphragm coupled to one end of the low-tone ring coil and configured to vibrate in response to the vertical movement of the low-tone ring coil and to output the low-tone in an upward direction.

6. The speaker unit of claim 1, wherein the low-tone yoke includes a plate-shaped structure.

7. The speaker unit of claim 1, wherein the high-tone speaker comprises
a plate-shaped high-tone yoke disposed above the low-tone diaphragm within the speaker frame;
a high-tone central magnet disposed above the high-tone yoke;
a high-tone ring magnet arranged above the high-tone yoke and on an outer side of the high-tone central magnet;
a high-tone plate-shaped coil disposed above the high-tone central magnet and the high-tone ring magnet; and
a high-tone diaphragm disposed above the high-tone plate-shaped coil and configured to output the high-tone in the same upward direction as the low-tone speaker.

8. The speaker unit of claim 7, wherein the high-tone plate-shaped coil includes a plate-shaped ring structure.

9. The speaker unit of claim 7, wherein the high-tone plate-shaped coil is formed as a coil structure or as a shaped circuit pattern on a flexible substrate.

10. The speaker unit of claim 7, wherein a flexible substrate for the high-tone is provided on an outer side of the high-tone plate-shaped coil to supply an electrical signal to the high-tone plate-shaped coil, a central portion of the flexible substrate for the high-tone has a hollow ring shape, and the high-tone plate-shaped coil is positioned in the central portion.

11. The speaker unit of claim 7, further comprising a microphone configured to convert external sound into an electrical signal,
wherein the microphone is arranged on a lateral portion of the high-tone speaker within the speaker frame.
